(19) United States
(12) Patent Application Publication
(10) Pub. No.: US 2002/0158123 A1
(43) Pub. Date: Oct. 31, 2002

(54) WEB-BASED SMART CARD SYSTEM AND METHOD FOR MAINTAINING STATUS INFORMATION AND VERIFYING ELIGIBILITY

(76) Inventors: Rodney F. Allen JR., Tallahassee, FL (US); William Daniel Norwood, Tallahassee, FL (US)

Correspondence Address: PORTER WRIGHT MORRIS & ARTHUR, LLP, INTELLECTUAL PROPERTY GROUP, 41 SOUTH HIGH STREET, 28TH FLOOR, COLUMBUS, OH, 43215

(21) Appl. No.: 09/772,579

(22) Filed: Jan. 30, 2001

(51) Int. Cl. G06K 5/00

(52) U.S. Cl. 235/380

(57) ABSTRACT

A system and method for verifying the eligibility of card holders for predetermined events such as entering a building or attending a sporting event is provided. The system and method includes interconnecting a central processing unit with a first database maintaining data concerning status information of a user and a second database maintaining data concerning eligibility parameters for a predetermined event. A first terminal, remote from the central processing unit, is interconnected in a network with the central processing unit. Data concerning the status information of a user is entered through the first terminal and data concerning the eligibility parameters for a predetermined event is entered through the first terminal. A smart card is generated having stored thereon the data concerning the status information of a user. A second terminal, remote from the central processing unit, is interconnected in a network with the central processing unit. The status information of a user stored on the smart card is read at the second terminal and the status information read from the card are compared against the eligibility parameters for a predetermined event to verify that a holder of the smart card is eligible for the predetermined event. Preferably the eligibility parameters are downloaded from the central processing unit and the second terminal is disconnected from the central processing unit while the smart cards are read and the status information is compared with the eligibility requirements.

### CROSS-REFERENCE TO RELATED APPLICATIONS

This application is related to our application Ser. No. 0x/xxx,xxx, “Vehicle Service and Maintenance Tracking Systems” and Ser. No. 0x/xxx,xxx, “Paperless System for the Display and Registry of Choices and the Collection of Data Entered Online and Offline in Elections and Surveys,” both filed concurrently herewith, and incorporated by reference herein as if set forth in full.

### STATEMENT REGARDING FEDERALLY SPONSORED RESEARCH OR DEVELOPMENT

Not Applicable

### REFERENCE TO MICROFICHE APPENDIX

Not Applicable

### BACKGROUND OF THE INVENTION

The present invention generally relates to a smart card system and, more particularly, to a web-based smart card system which compares status information stored on smart cards against eligibility parameters for a predetermined event to determine if the cardholder is eligible for the event such as, for example, entering a building, a stadium, a turnstile, a gate, an elevator, or the like.

Although in the example, a “university” setting is used with corresponding designations such as “freshman,” “sophomore,” “junior,” “senior,” etc., denoting status indicia, the invention is more broadly directed. The invention can be adapted to commercial and social or religious and other institutions, associations and organizations (businesses, clubs, etc.,). Corresponding changes adapted to the particular needs of the group can be made in the system relating to the designations and terms denoting status indicia and the qualifications and privileges within the group incident to a particular status.

In the prior art, a physical sticker has typically been attached to a traditional photo ID card, or the ID card which identifies that the card holder is eligible for the identified event. Additionally, the ID card has been used as a key to status information located on a central database. These prior art systems and methods have many disadvantages such as, for example, the stickers can be easily removed, copied, and are not revocable. As a result ineligible card holders attend or perform the events. Accordingly, there is a need in the art for an improved system and method which verifies that card holders are eligible for a predetermined event.

The system and method according to the present invention eliminates ineligible cardholders from attending certain events, limits access to buildings for current authorized users only, provides improved security based on encrypted data both on the card and in transmission, can be expired more frequently and/or revoked, and, offline, cannot be duplicated or removed. Furthermore, the present invention is a convenient electronic and paperless method to verify eligibility. The invention will be useful to institutions and businesses that require the verification of the status of cardholders. Certain aspects of smart cards and uses therefor are described, inter alia, in U.S. Pat. No. 5,679,945, “Intelligent Card Reader Having Emulation Features” and U.S. Pat. No. 5,969,316, “Smart Card for Offline Automated Meal Plans,” both issued to the assignee of the present application.

### BRIEF SUMMARY OF THE INVENTION

The present invention provides benefits and advantages over the related art described above and overcomes the problems thereof. The invention involves a web-based application that places several types of status (data) information onto a smart card. In a preferred university application, there are six (6) data fields that are placed the smart card, i.e., chip,: (1) Expiration Date 1, which identifies the expiration date of the status information; (2) Expiration Date 2, which identifies a secondary expiration date i.e., additional activities fees or birth date; (3) Major, which identifies the course of study; (4) Classification, which identifies where the cardholder stands in the field of study i.e., Freshman, Sophomore, etc.; (5) Status, which identifies the cardholder's institutional status i.e., Full time, part time, etc.; and (6) Entrance year, which identifies when the cardholder first enrolled at the institution.

In a preferred university application, the system works as follows. A client institution imports its data codes to a host via a website. In addition, the institution also imports cardholder data information i.e., the cardholder population with major, classification and identifying card numbers and Student Identifying Numbers, etc. This import is then converted to an 8-bit data string that is then written to the smart card. These two imports are entered into a database at the host. Because the data fields codes vary from institution to institution, the system provides the ability to cross-reference the institutions'codes table with the product's codes table to identify the variation thereby making the codes standard throughout using the system website. Administrators can create “eligibility lists” based on the status data fields for any desired usage. These lists are downloaded onto a personal computer or any personal computer/smart card reader and can be used as cardholders verification to get into certain events, buildings, etc. If a cardholder's information on their smart card is not current, the information can be updated via a personal computer/smart card reader and managed through the system website. This is done simply by the user inserting their smart card into the reader and verifying the information on the smart card to be correct or incorrect and then removing the card.

The system is preferably programmed using Visual Basic, Active Server Pages, Java and VB Script, SQL Server, Microsoft Front Page, Microsoft Notepad and C++ using smart cards.

According to the present invention, a system for verifying the eligibility of card holders for predetermined events, the system comprises a central processing unit interconnected with a first database in which data concerning status information of a user is maintained and a second database in which data concerning eligibility parameters for a predetermined event are maintained. A first terminal is remote from the central processing unit and is interconnected in a network with the central processing unit. Data concerning the status information of a user can be entered through the first terminal and data concerning the eligibility parameters for a predetermined event can be entered through the first terminal. A mechanism is provided for generating a smart card having stored thereon the data concerning the status information of a user. A second terminal is remote from the central processing unit and is interconnected in a network with the central processing unit. The second terminal includes a smart card reader so that the data concerning the status information of a user stored on the smart card can be compared against the eligibility parameters for a predetermined event to verify that a holder of the smart card is eligible for the predetermined event.

According to another aspect of the present invention, a method for verifying the eligibility of card holders for predetermined events comprises the steps of interconnecting a central processing unit with a first database maintaining data concerning status information of a user and a second database maintaining data concerning eligibility parameters for a predetermined event. A first terminal, remote from the central processing unit, is interconnected in a network with the central processing unit. Data concerning the status information of a user is entered through the first terminal and data concerning the eligibility parameters for a predetermined event is entered through the first terminal. A smart card is generated having stored thereon the data concerning the status information of a user. A second terminal, remote from the central processing unit, is interconnected in a network with the central processing unit. The status information of a user stored on the smart card is read at the second terminal and the status information read from the card is compared against the eligibility parameters for a predetermined event to verify that a holder of the smart card is eligible for the predetermined event.

The invention is described more fully in the following description of the preferred embodiment considered in view of the drawings in which:

### BRIEF DESCRIPTION OF THE SEVERAL VIEWS OF THE DRAWING

FIG. 1 is a web site diagram for a smart card system for checking card holder status information to verify eligibility for specific events according to the present invention;

FIG. 2 is logical overview of the smart card system for checking card holder status information to verify eligibility for specific events according to the present invention and how it might interface with other systems;

FIG. 3 is a high-level data flow diagram of the smart card system;

FIG. 4 is a match codes data flow diagram identified as SS1 on FIG. 3;

FIG. 5 is an import codes data flow diagram identified as SS2 on FIG. 3;

FIG. 6 is an automatic card update data flow diagram identified as SS3 on FIG. 3;

FIG. 7 is a manual card update data flow diagram identified as SS4 on FIG. 3;

FIG. 8 is a check current status data flow diagram identified as SS6 on FIG. 3;

FIG. 9 is a create/edit eligibility lists data flow diagram identified as SS7 on FIG. 3;

FIG. 10 is an eligibility lists retrieval data flow diagram;

FIG. 11 is a positive/negative response data flow diagram;

FIG. 12 shows a database overview identified as SS9 on FIG. 3;

FIG. 13 is a create/edit codes/descriptions data flow diagram identified as SS11 on FIG. 3; and

FIG. 14 is a convert codes data flow diagram identified as SS13 on FIG. 3.

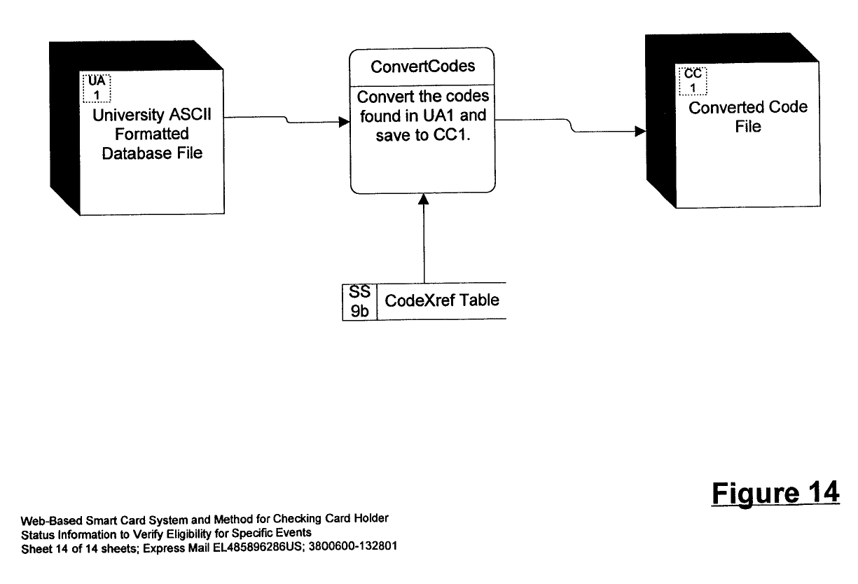

### DETAILED DESCRIPTION OF THE INVENTION

It will be apparent to those skilled in the art, that is, to those who have knowledge or experience in this area of technology, that many uses and design variations are possible for the improved smart card system and method disclosed herein. The following detailed discussion of various alternative and preferred embodiments will illustrate the general principles of the invention with reference to an embodiment for use with a university or educational institution having a plurality of students and faculty. Other embodiments suitable for other applications will be apparent to those skilled in the art given the benefit of this disclosure such as, for example, a company having a plurality of employees.

1.0 System Overview

A Current Status Classification Update Program (CS) is intended to be the unifying core for a plurality of smart card applications in a common system. The functionality contained in CS falls under two general categories. The CS will be used to maintain and update the system smart cards, and to maintain the integrity of that information through various methods.

1.1 Graphical User Interface

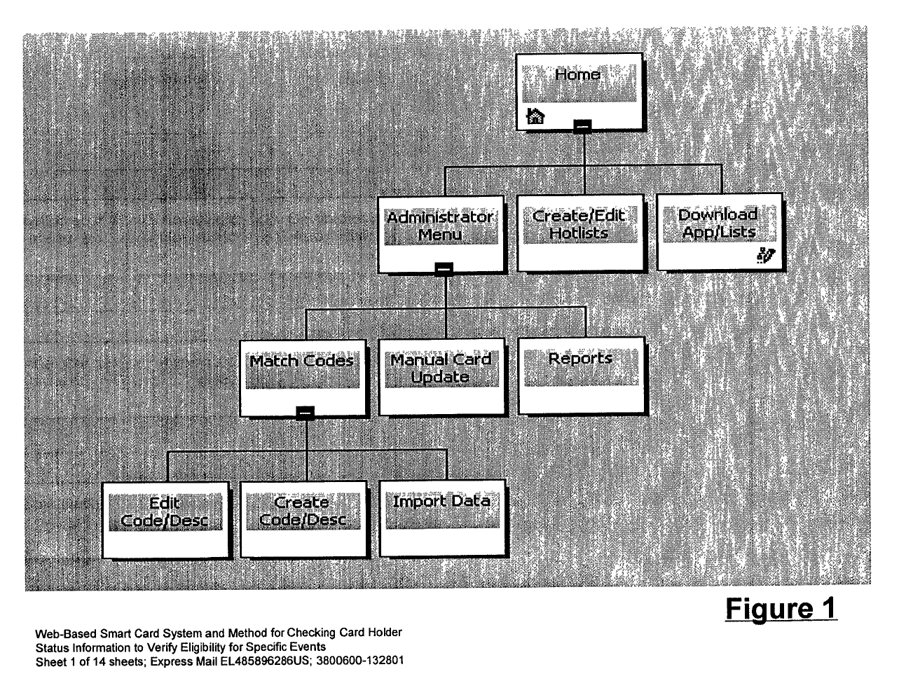

A user will use Internet Explorer 4.0 to access the CS site server (see FIG. 1). All screens will have a consistent efficient look and feel to them. The goal of the user interface is to provide ease of usability and data entry, while conforming to an established standard for web page appearance.

The heart of the CS is an access database. This access database houses all of the information needed by the CS site server to support the required feature set. The site server uses server side scripts, cgi's or a combination of each to create a dynamic interface that can be unique for each user accessing the site.

1.2 Dynamic Access

An administrator is granted access to the site only after fulfilling certain security requirements such as, for example, a pass word. After the administrator logs onto the site the site server displays a dynamically built list of options. This list is built based on the administrators security level. Only items that require a security level less than or equal to the administrator's security level will be accessible. All other functionality will be visible but disabled.

1.3 Information Maintenance

Using CS, the administrator, provided they possess the correct security clearance, is able to maintain the status, classification, major code, expiration date, entrance date, and date of birth contained on the smart card. The administrator is also able to manipulate eligibility requirements, generate lists and reports, and import data from university databases.

2.0 Site Diagram

FIG. 1 illustrates a preferred web site diagram for performing the below described functions.

2.0 Logical Overview

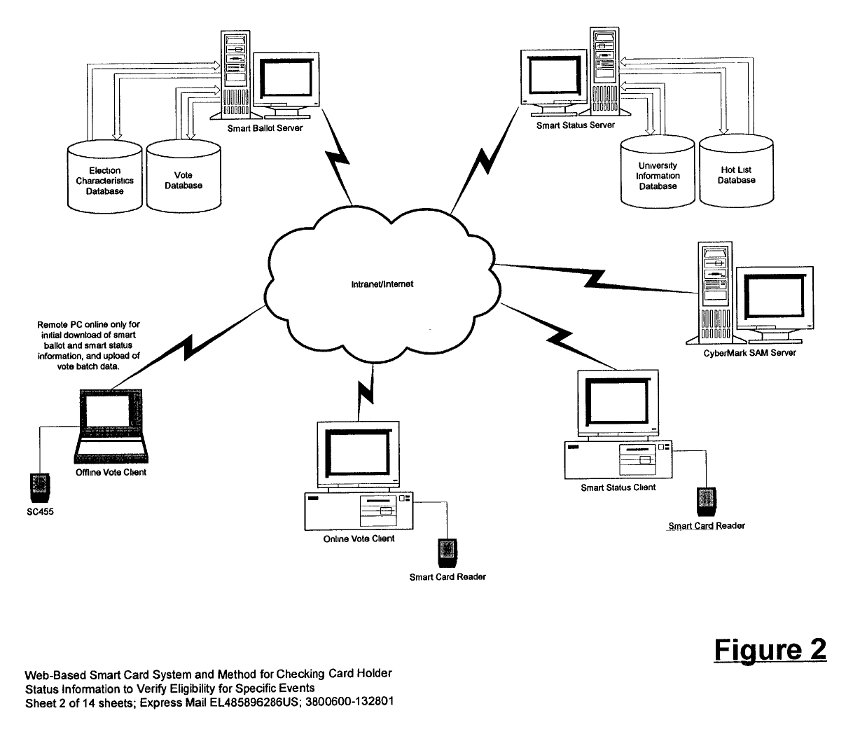

FIG. 2 illustrates the CS system and how it can interface to other smart card applications or systems. The CS system is used as a base for the other smart card systems, however, it is a standalone system in it's own right. It supplies the user with unique and useful functionality for use in administrating its status and eligibility system.

4.0 Data flow Diagrams

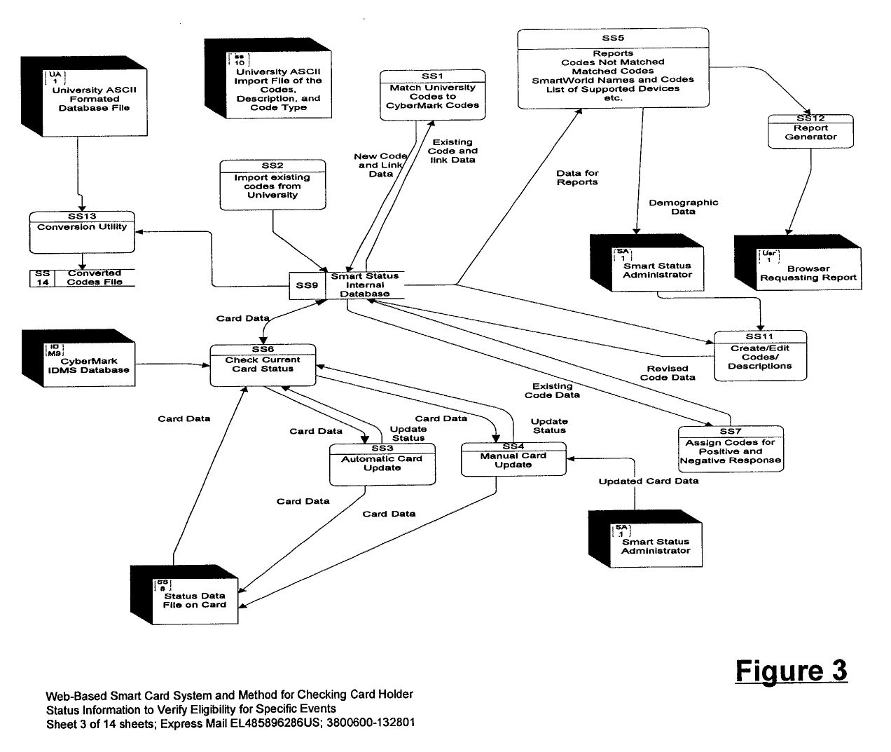

FIG. 3 is a high-level data flow diagram for the CS system

SS1—Match University Codes to Host (such as CyberMark) Codes

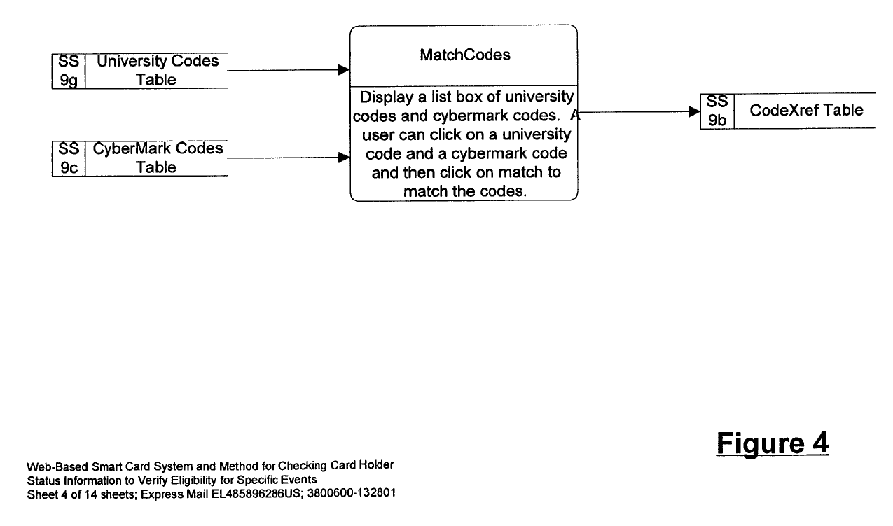

The administrator is able to match codes contained on the smart card which are used by the host, to codes contained in the university database. FIG. 4 shows a detailed data flow of the Match University Codes to Host (CyberMark) Codes process.

SS2—Import Existing Codes from University Flat ASCII File

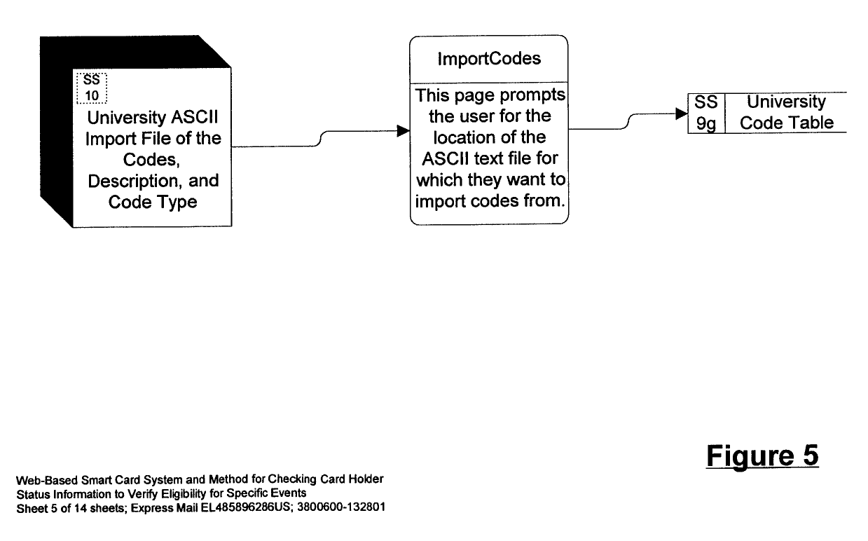

This import utility allows the administrator to obtain status codes from the university without having to manually enter all the codes. This screen is accessed through the Match Codes screen. FIG. 5 shows a detailed data flow diagram of the Import Codes process.

SS3—Automatic Card Update

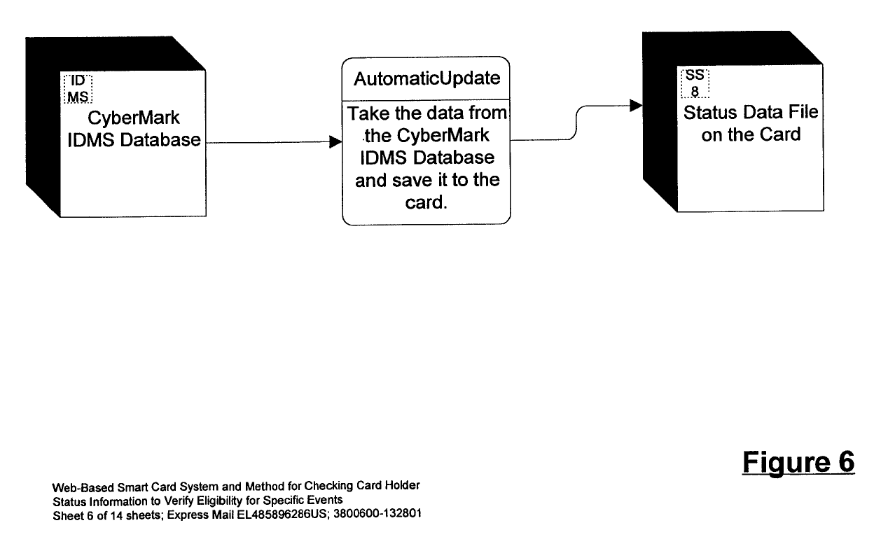

When the user inserts the smart card into a reader, the CS program acquires the current profile in the host (CyberMark) database. The CS program compares this information to the current card profile. If the information is not identical, the CS program updates the card and prompts the user with the update status, and asks them to remove the card from the reader. FIG. 6 shows a detailed data flow diagram of the Automatic Card Update.

SS4—Manual Card Update

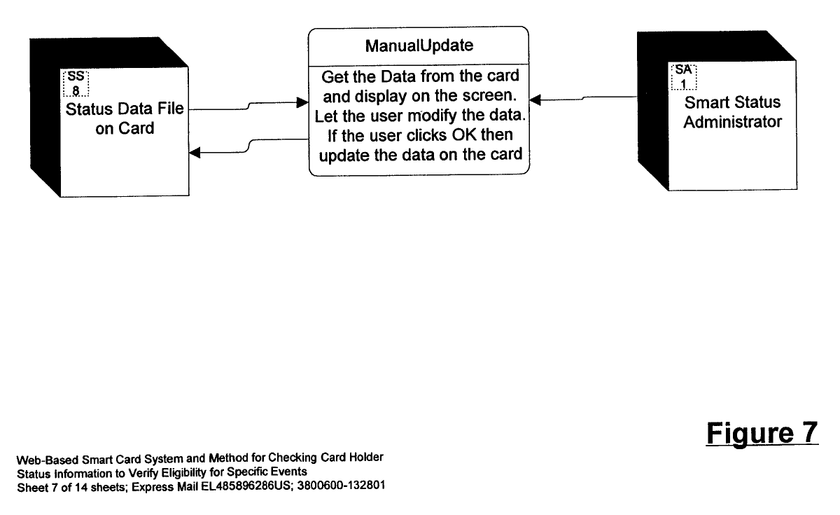

When the Administrator inserts the smart card, the CS program acquires the current profile in the university database, displaying it and the current card profile on the display device. If any status information is not in agreement, Automatic Card Update updates the card with the current university data. The screen shows the data that is on the card, allowing the administrator to change the data on the card. Once the administrator is done with the updates, clicking an “OK” button saves the data to the smart card. If the administrator does not click the “OK” button, the data is NOT written to the smart card. Manual Card Update does NOT modify the data in the university database. Any changes made to the smart card must be made in the university database; otherwise, an Automatic Card Update updates the smart card with the data found in the university database. FIG. 7 shows a detailed data diagram of Manual Card Update. Functionality can allow fields to be enabled/disabled according to the administrator's security level.

SS5—Reports

The CS application is capable of generating a multitude of reports. These reports are viewed through a web browser. An export button can be provided to export any reports to a comma delimited text file. Allowances can be made for other reports to be generated. The reports can include: (1) an Administrator Logging Report which shows user card number, Student Identifying Number and time they logged in; (2) Cards Manually Updated Report which shows user card number, time, Student Identifying Number, values changed, and current corresponding fields of the card database; (3) a Cross Reference Report which outlines names and university codes and which host (CyberMark) names and codes they match; (4) an Unmatched University Codes Report which details which university codes have not been associated with a host (CyberMark) card code; (5) a Codes Used/Free Report which details the number of codes used for each editable data type (major, status, school) and the remaining number of unassociated codes for each data type; (6) a Log Report which reports for the logged events outlined below; (7) an Eligibility Jobs Report which details the criteria for each job, who created it, and comments by the creator outlining the intended use. The CS application can be configured to support any or all of these reports depending on the needs of the university.

SS6—Check Current Card Status

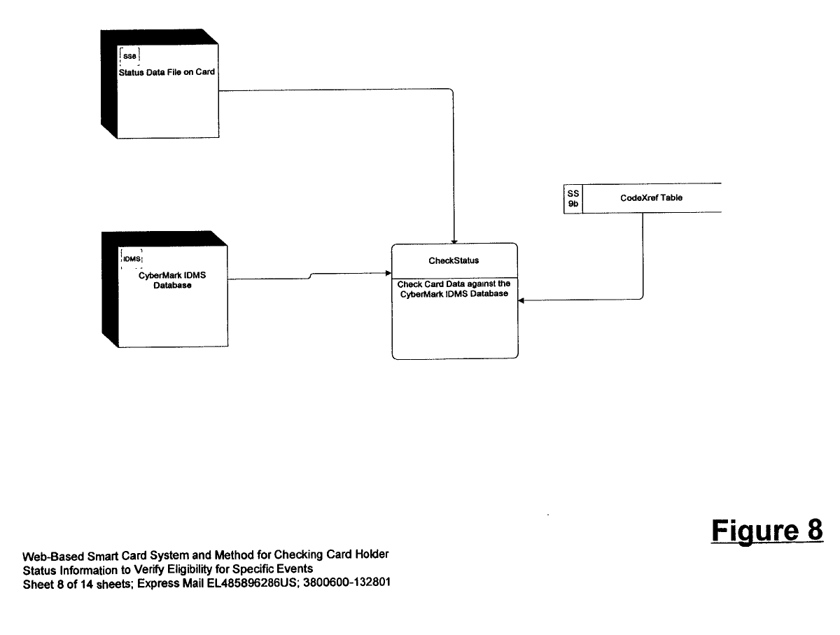

While running CS, a cardholder may insert their smart card to verify the status information contained on their card. The CS program acquires the current profile in the university database. The user is prompted if they want to update their card only if the current date is past the expiration date. Otherwise, if any information on the card is not in agreement with the host (CyberMark) IDMS database, Check Current Card Status calls Automatic Card Update to update the data on the card. FIG. 8 shows a detailed data flow of Check Current Card Status.

SS7—Assign Codes for Positive/Negative Lookup

The administrator is able to create lists of eligibility codes. Each list is assigned a unique ID. Based on these lists, a cardholder may be deemed eligible, or ineligible by checking the codes on their smart card. This list resides on the server, and various client devices may contact the server and request a hot list by its ID. The server verifies the identity of the client device, and then forwards the appropriate list to the device. The verification of cardholder eligibility is ultimately the responsibility of the client device. CS fulfills only the role of hot list (eligibility/ineligibility) server.

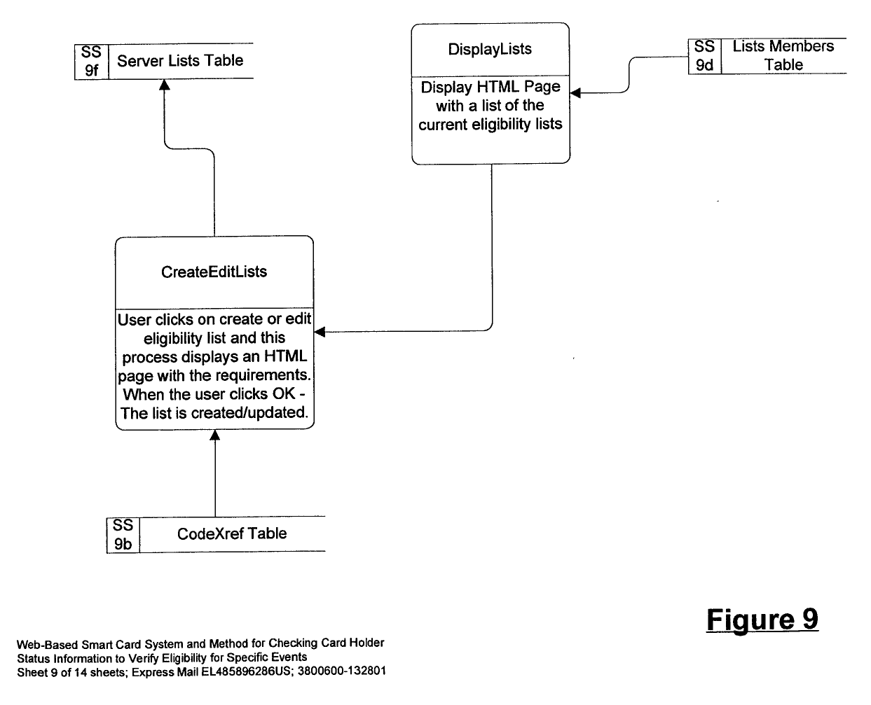

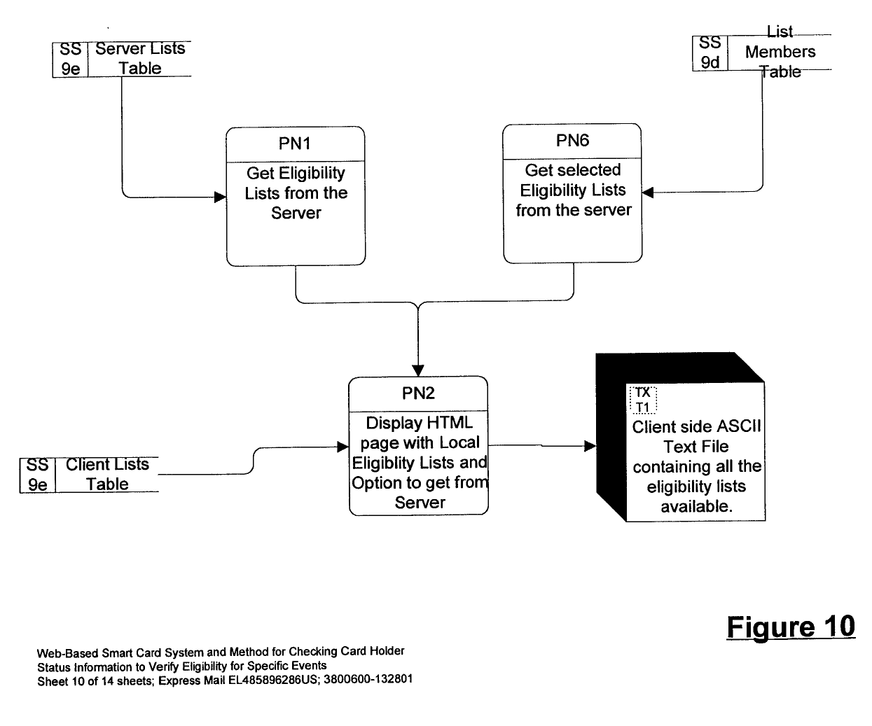

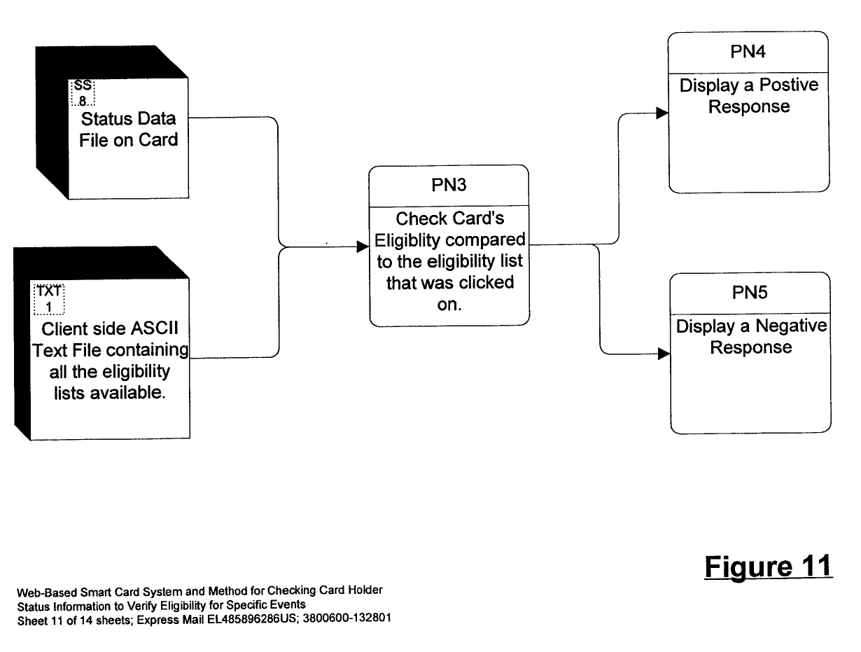

The Positive/Negative lookup is a separate application. This application will check the cardholder's eligibility characteristics and compare them to an eligibility list located on the PC. If the cardholder's eligibility matches the eligibility list then a positive response (green screen) will be returned, otherwise a negative response (red screen) will be returned. This application can be used for evens such as access to seminars, sporting events, and general activities. This program is also useful for students to determine if they are eligible for certain events or rewards. The university is able to create eligibility lists, which can be downloaded to any PC that is interconnected to the Internet and has a PC/SC smart card reader. Once the information is downloaded off the Internet, the PC can be disconnected and the Positive/Negative program still functions. The eligibility lists that are downloaded from the server are stored in an ASCII text file on the PC. The user on the PC has the option of deleting the local eligibility lists, transmitting an eligibility list to a POS terminal (implemented in the future), or clicking on an eligibility list and running the Positive/Negative program. FIG. 9 shows a detailed data flow diagram of Create/Edit Eligibility Lists. FIG. 10 shows a detailed data flow diagram of the Positive/Negative Look up or Retrieval. FIG. 11 shows a detailed data flow diagram of the Positive/Negative Response. This process can have the positive or negative response send a pulse out the rs 232 port. This would be used to control a turnstile, unlock a door, flash a light, etc.

SS8—Status Data File on Card

The Status Data File is located on the smart card and contains all card data necessary to check and update the status of the cardholder. The files accessed by CS preferably have the following layout:

| | Number of | |
|---|---|---|
| Data | Bits | |
| Current | 4 | Expiration MM (12 months) |
| Status | | |
| Expiration | | |
| Month | | |
| Current | 5 | Expiration DD (31 days) |
| Status | | |
| Expiration | | |
| Day | | |
| Current | 8 | Expiration YY (256 years) |
| Status | | Starts at 1900 |
| Expiration | | |
| Year | | |
| Major | 10 | Up to 1048 majors |
| Status | 6 | Student, Faculty up to 64 |
| School | 4 | Up to 16 |
| Birth | 4 | DOB MM (12 months) |
| Month | | |
| Birth Day | 5 | DOB DD (31 days) |
| Birth Year | 8 | DOB YY (256 years) |
| | | Starts at 1900 |
| Entrance | 8 | YY (256 years) |
| Year | | Starts at 1900 |
| Total Bits | 63 | |

SS9—Smart Status Internal Database

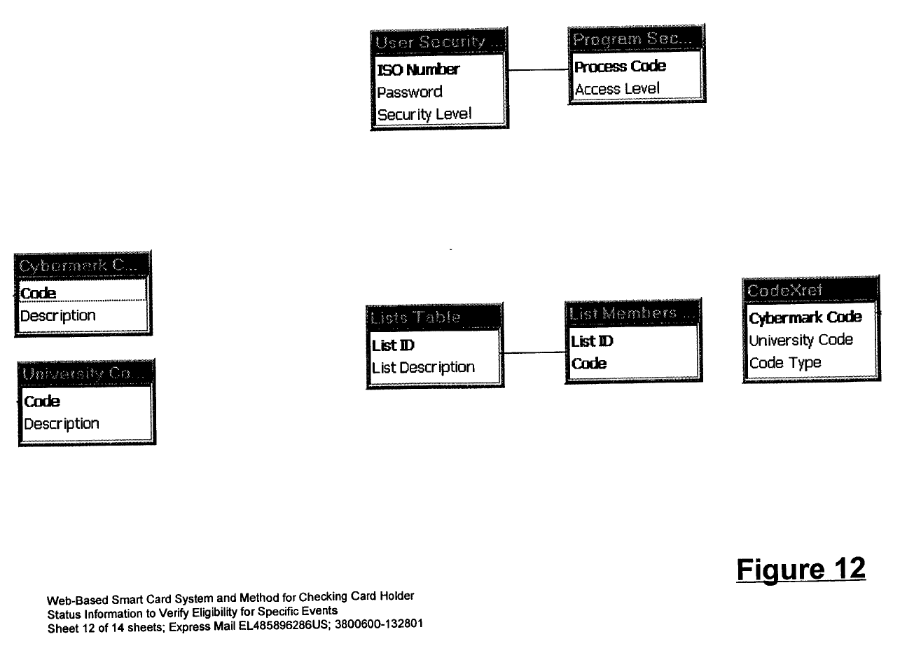

FIG. 12 provides a general overview of the database implemented as part of the CS system. A more detailed definition is provided below. This internal database is at the center of the CS system. It controls security, program functionality, and houses all status code and hot list\eligibility information.

SS9a - Table: Activity Log
Columns

| Name | Type | Size |
|---|---|---|
| Reference Number | Number (Long) | 4 |
| Action Code | Number (Byte) | 1 |
| Date Time | Date/Time | 8 |
| Description | Text | 80 |

Table Indexes

| Name | Number of Fields |
|---|---|
| Action Code | 1 |
| Fields: | Action Code, Ascending |
| PrimaryKey | 1 |
| Fields: | Reference Number, Ascending |

SS9b - Table: CodeXref
Columns

| Name | Type | Size |
|---|---|---|
| host (Cybermark) Code | Number (Byte) | 1 |
| University Code | Number (Byte) | 1 |
| Code Type | Number (Byte) | 1 |

Table Indexes

| Name | Number of Fields |
|---|---|
| PrimaryKey | 1 |
| Fields: | host (Cybermark) Code, Ascending |
| SecondaryKey | 1 |
| Fields: | University Code, Ascending |

SS9c - Table: Host (CyberMark) Codes
Columns

| Name | Type | Size |
|---|---|---|
| Code | Number (Byte) | 1 |
| Description | Text | 15 |

Table Indexes

| Name | Number of Fields |
|---|---|
| Code | 1 |
| Fields: | Code, Ascending |
| CodeXrefCybermark Codes | 1 |
| Fields: | Code, Ascending |
| PrimaryKey | 1 |
| Fields: | Code, Ascending |

SS9d - Table: List Members Table
Columns

| Name | Type | Size |
|---|---|---|
| List ID | Number (Long) | 4 |
| Code | Number (Byte) | 1 |

Table Indexes

| Name | Number of Fields |
|---|---|
| Code | 1 |
| Fields: | Code, Ascending |
| List ID | 1 |
| Fields: | List ID, Ascending |
| PrimaryKey | 2 |
| Fields: | List ID, Ascending |
| | Code, Ascending |

SS9e - Table: Lists Table
Columns

| Name | Type | Size |
|---|---|---|
| List ID | Number (Long) | 4 |
| List Description | Text | 50 |

Table Indexes

| Name | Number of Fields |
|---|---|
| List ID | 1 |
| Fields: | List ID, Ascending |
| PrimaryKey | 1 |
| Fields: | List ID, Ascending |

SS9f - Table: Program Security Table
Columns

| Name | Type | Size |
|---|---|---|
| Process Code | Number (Byte) | 1 |
| Access Level | Number (Byte) | 1 |
| Table Indexes | | |
| Name | Number of Fields | |
| PrimaryKey | 1 | |
| Fields: | Process Code, Ascending | |
| Process Code | 1 | |
| Fields: | Process Code, Ascending | |

SS9g - Table: University Codes
Columns

| Name | Type | Size |
|---|---|---|
| Code | Number (Byte) | 1 |
| Description | Text | 15 |

Table Indexes

| Name | Number of Fields |
|---|---|
| Code | 1 |
| Fields: | Code, Ascending |
| CodeXrefUniversity Codes | 1 |
| Fields: | Code, Ascending |
| PrimaryKey | 1 |
| Fields: | Code, Ascending |

SS9h - Table: User Security Table
Columns

| Name | Type | Size |
|---|---|---|
| ISO Number | Text | 25 |
| Password | Text | 10 |
| Security Level | Number (Byte) | 1 |

Table Indexes

| Name | Number of Fields |
|---|---|
| PrimaryKey | 1 |
| Fields: | ISO Number, Ascending |

The data contained in the ASCII import file preferably has the following format:

| Field Name | PIC | Description |
|---|---|---|
| Code Type | 9(1) | Numeric Value indicating code type |
| | | 1 - Major Code |
| | | 2 - Status Code |
| | | 3 - School Code |
| | | 4 - Sex Code |
| | | 5 - Race Code |
| Comma | 0x2C | Used as a field Separator |
| Code Number | 9(2) | Value Assigned by the University |
| Comma | 0x2C | Used as a field Separator |
| Double Quote | 0x22 | Used as a text string delimiter |
| Code | X(25) | Text Description of this code |
| Description | | |
| Double Quote | 0x22 | Used as a text string delimiter |
| CR | 0x0D | Carriage Return Character 0x0D |
| LF | 0x0A | Line Feed Character 0x0A |

SS11—Create/Edit Codes/Descriptions

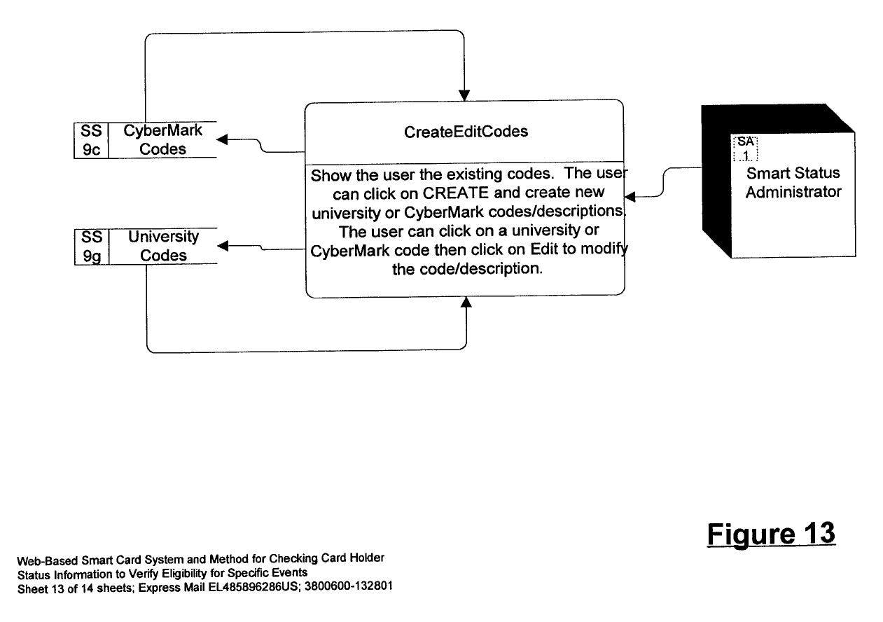

The administrator is able to create new codes or edit existing codes from the University Code Table and the Host (CyberMark0 Code Table. From the Match Codes screen, the user can click on CREATE codes which then prompts the following information: Code Type (university or host (CyberMark)), Code, and Description. From the Match Codes screen the user can click on EDIT codes and is then prompted to select a code from either the University Code Table or the Host (CyberMark) Code Table. The same screen is displayed as the Create Codes screen with the values already filled in. The user can then change the values. The values are saved to the database when the user clicks on OK. The host (CyberMark) defines what the default code values are and the codes that cannot be edited. FIG. 13 shows a detailed data flow diagram of Create/Edit Codes/Description.

SS12—Report Generator

According to the type of report that is to be generated, Report Generator takes the data, parses it, and formats it to fit on the screen in a presentable format.

SS13—Conversion Utility

The Conversion utility is responsible for converting the raw university code data into the appropriate format for the master system (CyberMark ID Management System) to import. This utility reads the University code data for each card number and Student Identifying Number, converts the codes according to the values contained in the Smart Status database, and appends the card number and Student Identifying Number converted codes to the end of a flat ASCII file. This utility is preferably the responsibility of the master system (CyberMark ID Management System) import utility to purge the contents of this file. If there is a problem converting the University code data to a corresponding host (Cybermark) code, the utility writes the data to a log file, omits it from the converted code file, and proceeds to process the next record in the University code data file. FIG. 13 shows a detailed data flow of the conversion process.

CC1—Converted Code File

The Converted Code file contains the output from SS13. This file preferably has the following format.

| Field Name | PIC | Description |
|---|---|---|
| ISO Number | Var | Numeric Value representing the cardholder |
| | | ID |
| Comma | 0x2C | Used as a field Separator |
| Card Data | 1(60) | Binary Value represent the data contained |
| | | in cal7 on the card |
| CR | 0x0D | Carriage Return Character 0x0D |
| LF | 0x0A | Line Feed Character 0x0A |

CyberMark ID Management System Host: Card Database

This host CyberMark ID Management System Host Card Database holds all the current information for all the smart cards at a certain campus. CS uses ODBC calls to read data from this database. CS preferably will never update this database.

SA1—Status Administrator

A user with administrative access that can edit codes and card data.

Usrl—Browser Requesting Report

A user's browser which displays data

UA1—University ASCII Formatted Database File

The University will export their data to a comma delimited text file. The text file will look like the one shown in the table below. This file contains the data from the University Database. The file will have the following format.

| Field Name | PIC | Description |
|---|---|---|
| Card Number | Var | Numeric Value representing the cardholder |
| | | ID |
| Comma | 0x2C | Used as a field Separator |
| Expiration | 9(8) | Expiration Date of the student's ID. Stored |
| Date | | as MMDDYYYY. |
| Comma | 0x2C | Used as a field Separator |
| University | X(X) | University Major Code represented by the |
| Major Code | | university database. |
| Comma | 0x2C | Used as a field Separator |
| University | X(X) | University Major Code represented by the |
| Status Code | | university database. |
| Comma | 0x2C | Used as a field Separator |
| University | X(X) | University School Code represented by the |
| School Code | | university database. |
| Comma | 0x2C | Used as a field Separator |
| Birthdate | 9(8) | Student's Date Of Birth. Stored as |
| | | MMDDYYYY. |
| Comma | 0x2C | Used as a field Separator |
| Entrance | 9(4) | Student's Entrance Year to the school. |
| Year | | Stored as YYYY. |
| CR | 0x0D | Carriage Return Character 0x0D |
| LF | 0x0A | Line Feed Character 0x0A |

A field comparable to the form and structure used with the Card Number may be added to contain the Student Identifying Number.

Logging Levels

Log entries will be required for the following events: Code matching/editing—data and authorized person which performed the code matching/editing; Import of University Codes—date and time of import and any failed/corrupted records (please suggest a definition) that occur doing conversion; Import of University Student Data—date and time of import, number of records imported, number of records converted, card number of any failed conversions or corrupted records, Student Identifying Number; Manual Updates to any card—which card updated, which authorized person performed the manual update, date and time, and which fields were altered; and Eligibility list creation—logs who created which eligibility job with date and time stamp.

Only specifically authorized users will be able to view/delete the log.

Default Data Types

Major, Status, School are the editable data types. Expiration, Birth and Entrance Dates are fixed dates starting in 1999, 1900 and 1980, respectively.

Default Host (CyberMark) Codes

Default Codes for Major are preferably:

| | | | | | |
|---|---|---|---|---|---|
| 01 | Agriculture | 1 | Fine and performing | 19 | Personal and |
| | | 0 | arts | | miscellaneous |
| | | | | | services |
| | | | | | (cosmetology, |
| | | | | | culinary |
| | | | | | arts, massage, |
| | | | | | etc.) |
| 02 | Architecture | 1 | Foreign | 20 | Philosophy |
| | | 1 | languages/literatures | | |
| 03 | Biological Sciences | 1 | Health profession | 21 | Physical |
| | (biology, zoology, | 2 | (except nursing) | | Sciences |
| | etc.) | | | | (chemistry, |
| | | | | | physics, |
| | | | | | geology, etc.) |
| 04 | Business | 1 | Home economics | 22 | Social sciences |
| | Management and | 3 | | | and history |
| | | | | | (includes |
| | Administrative | | | | economics, |
| | Services (mktg., | | | | geography, |
| | mgmt., bkkp., | | | | political |
| | acct., etc.) | | | | science) |
| 05 | Communications | 1 | Law | 23 | Psychology |
| | (journalism, | 4 | | | |
| | advertising, etc.) | | | | |
| 06 | Computer Sciences | 1 | Liberal Arts | 24 | Theological |
| | | 5 | | | studies and |
| | | | | | religious |
| | | | | | vocations |
| 07 | Education | 1 | Library Sciences | 25 | Vocation/ |
| | | 6 | | | technical |
| | | | | | (construction, |
| | | | | | mechanical, |
| | | | | | transportation, |
| | | | | | etc.) |
| 08 | Engineering | 1 | Mathematics | 26 | Wildlife, |
| | | 7 | (includes | | forestry, or |
| | | | statistics) | | marine sciences |
| 09 | English | 1 | Nursing | 27 | Other/ |
| | | | | | undecided |
| | Language/Literature | 8 | | | |

Status default codes are preferably: faculty; staff; administration; freshman; sophomore; junior; senior; graduate student; doctoral candidate; post-doctoral researcher; and other.

Security

Preferably, there are two different tables in this program to regulate security in the CS program. One table is user security. This table is shipped to the host (CyberMark) with no data in it. The other table is program security. This table also will be shipped to the host (CyberMark) with all the processes found in the CS program. All processes are set to a security level of zero, which gives all users access to all processes. Restricting a user to certain processes requires high security levels set for those processes. If a user has a security level of equal or greater than the security level set for that process, he is able to perform that process. All processes have a method field also. This method field is set to zero for a smart card security checking. The method field is set to one for password security checking. The method field is set to 2 for both smart card and password security checking. All editing/modifying of user security levels and process security levels is done through access and manually typing the information into the tables. It is believed there is too much risk involved with having this process being done over the Internet.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A system for verifying the eligibility of card holders for predetermined events, the system comprising:
a central processing unit interconnected with a first database in which data concerning status information of a user is maintained and a second database in which data concerning eligibility parameters for a predetermined event are maintained;
a first terminal remote from the central processing unit and interconnected in a network with the central processing unit, wherein data concerning the status information of a user can be entered through the first terminal and data concerning the eligibility parameters for a predetermined event can be entered through the first terminal;
a mechanism for generating a smart card having stored thereon the data concerning the status information of a user; and
a second terminal remote from the central processing unit and interconnected in a network with the central processing unit, wherein the second terminal includes a smart card reader so that the data concerning the status information of a user stored on the smart card can be compared against the eligibility parameters for a predetermined event to verify that a holder of the smart card is eligible for the predetermined event.

2. The system according to claim 1, wherein the first terminal is interconnected to the central processing unit via the Internet.

3. The system according to claim 1, wherein the second terminal is interconnected to the central processing unit via the Internet.

4. The system according to claim 1, wherein the data stored on the smart card includes a first expiration date which identifies an expiration date of the status information, a second expiration date which identifies a date of birth of the user, a major which identifies a field of study of the user at an institution, a classification which identifies where the user stands in the field of study, status which identifies a status of the user at the institution, and entrance year which identifies when the user enrolled at the institution.

5. The system according to claim 1, wherein data stored on the smart card is an 8-bit data string.

6. The system according to claim 1, wherein the second terminal is interconnected in a network with the first database so that the status information of a user stored on the smart card can be compared against the status information of a user in the first database to verify that the status information stored on the card is up to date.

7. The system according to claim 1, wherein the central processing unit is adapted to convert data concerning status information entered through the first terminal into a standard data code.

8. The system according to claim 7, wherein the central processing unit is adapted to provide a cross-reference between the data concerning information entered through the first terminal and the standard data code which is accessible through the first terminal.

9. The system according to claim 1, further comprising a mechanism for updating the status information stored on the smart card to match current data stored in the first database.

10. A method for verifying the eligibility of card holders for predetermined events, the method comprising the steps of:
(a) interconnecting a central processing unit with a first database maintaining data concerning status information of a user and a second database maintaining data concerning eligibility parameters for a predetermined event;
(b) interconnecting a first terminal, remote from the central processing unit, in a network with the central processing unit;
(c) entering data concerning the status information of a user through the first terminal and data concerning the eligibility parameters for a predetermined event through the first terminal;
(d) generating a smart card having stored thereon the data concerning the status information of a user;
(e) interconnecting a second terminal, remote from the central processing unit, in a network with the central processing unit;
(f) reading the status information of a user stored on the smart card at the second terminal; and
(g) comparing the status information read from the card against the eligibility parameters for a predetermined event to verify that a holder of the smart card is eligible for the predetermined event.

11. The method according to claim 10, wherein the step of interconnecting the first terminal in a network with the central processing unit includes interconnecting the first terminal to the central processing unit via the Internet.

12. The method according to claim 10, wherein the step of interconnecting the second terminal in a network with the central processing unit includes interconnecting the second terminal to the central processing unit via the Internet.

13. The method according to claim 10, wherein the step of generating a smart card includes storing, on the smart card, a first expiration date which identifies an expiration date of the status information, a second expiration date which identifies a date of birth of the user, a major which identifies a field of study of the user at an institution, a classification which identifies where the user stands in the field of study, status which identifies a status of the user at the institution, and entrance year which identifies when the user enrolled at the institution.

14. The method according to claim 10, further comprising the step of comparing the status information of a user in the first database and the status information read the smart card to verify that the status information stored on the smart card is up to date.

15. The method according to claim 14, further comprising the step of updating the status information on the smart card if it does not match the status information of the user in the first database.

16. The method according to claim 10, further comprising the step of converting data concerning status information entered through the first terminal into a standard data code for storage in the first database.

17. The method according to claim 16, further comprising the step of providing a cross-reference between the data concerning information entered through the first terminal and the standard data code stored in the first database which is accessible through the first terminal.

18. The method according to claim 10, further comprising the step of downloading data concerning eligibility parameters for a predetermined event from the second database to the second terminal prior to the step of comparing the status information read from the card against the eligibility parameters for a predetermined event.

19. The method according to claim 18, further comprising the step of disconnecting the second terminal from the central processing unit after the step of downloading data concerning eligibility parameters for a predetermined event from the second database to the second terminal and prior to the step of comparing the status information read from the card against the eligibility parameters for a predetermined event.
